(19) United States
(12) Patent Application Publication
(10) Pub. No.: US 2010/0130241 A1
(43) Pub. Date: May 27, 2010

(54) Wireless Communication Terminal Apparatus

(75) Inventor: Mitsuhiro Kitaji, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/516,784

(22) PCT Filed: Nov. 28, 2007
(86) PCT No.: PCT/JP2007/072957

§ 371 Date: Dec. 18, 2009

(30) Foreign Application Priority Data
Nov. 29, 2006 (JP) 2006-322130

(51) Int. Cl. H04B 7/00

(52) U.S. Cl. 455/509

(57) ABSTRACT

A wireless communication terminal apparatus having a plurality of wireless communication units (180, 190) having different communication methods and capable of performing wireless communications simultaneously through respective wireless communication paths using the wireless communication units include a RSSI acquisition unit (110) for acquiring RSSI of each wireless communication unit based on a received signal when receiving data by each wireless communication unit, a data allocation unit (162) for allocating the data to be transmitted to each wireless communication unit based on a transmission ratio, a transmission bandwidth acquisition unit (132) for acquiring, for each of wireless communication units, each transmission bandwidth required for each data that has been allocated to each wireless communication unit, a predicted value calculation unit (134) for determining the total of each current consumption predicted value of each wireless communication unit to which the data has been allocated based on each RSSI and each transmission bandwidth acquired by the transmission bandwidth acquisition unit and with reference to a transmission-bandwidth versus current-consumption table (TB1) showing the relationship among transmission bandwidth, RSSI and current consumption, and a control unit (160) for controlling the data allocation unit to modify and allocate the transmission ratio so that the total of each current consumption predicted value may not exceed a predetermined threshold.

### TECHNICAL FIELD

The present invention relates to a wireless communication terminal apparatus and, in particular, to a wireless communication terminal apparatus that avoids inconveniences caused by an increase in current consumption when communications are performed by using more than one wireless communication units.

### BACKGROUND ART

In a terminal including a plurality of wireless communication units, when the allowable bandwidth of a master path is insufficient with respect to a bandwidth required by an application, it is possible to compensate for the insufficient bandwidth by using a slave path. However, since such a plurality of wireless communication units consumes electrical power independently, the following problems occur.

FIG. 1 is a graph illustrating the relationship among transmission power (electrical power) of a communication terminal, RSSI (Received Signal Strength Indicator, which is a value that can be converted from the received signal strength/electrical power) and transmission rate (bandwidth). In general, for a communication system that can modify the transmission rate, that is, a transmission bandwidth of a terminal, the transmission rate decreases as the error resilience increases. In other words, there is a trade-off relationship between the error resilience and the transmission rate. Therefore, on the contrary, when transmissions are performed at a high transmission rate, the error resilience decreases. Because of this, at a high rate, transmissions are performed by increasing transmission power in order to compensate for a decrease in the error resilience at a high rate. In addition, also at a specific transmission rate, the transmission power is dependent on a wireless state such as RSSI. For example, even with respect to terminals that transmit at the same transmission rate, when the terminal is in a good wireless state and close to the base station, the transmission power is small, and when the terminal is in a poor wireless state and away from the base station, the transmission power is large. Further, the maximum transmission power is set for a terminal, therefore, the construction thereof does not allow transmissions exceeding this maximum transmission.

Generally, in a wireless communication system, transmissions and receptions are performed based on a wireless frame and a transmission timing determined preliminarily by a protocol or the like. Therefore, in the case where large-volume IP packets are transmitted, one IP packet is carried by several times of wireless frames by fragment, or on the contrary, in the case of small-volume IP packets, a plurality of IP packets are carried by one wireless frame. Further, when the wireless frame length is fixed and all of the wireless frames are not filled by the timing when wireless frames are transmitted, they are filled with padding and then transmitted. Therefore, a wireless (physical layer) transmission rate is fixed in accordance with some levels, and a rate to be used is determined based on inflow of IP packets or the like. On the other hand, the higher the transmission rate is, the higher the transmission power is made in order to increase the error resilience, and transmissions are performed. However, the larger the transmission power is, the larger the current consumption is. Therefore, the current consumption for transmissions at a terminal increases as the transmission power increases. In the case where a large amount of transmission power is required due to the poor wireless state or the transmission power is high due to a high transmission rate or the like, compared to the opposite case, the current consumption increases. Accordingly, the battery consumption increases.

In addition, in some communication systems, due to limitation of the maximum transmission power (electrical power), with respect to a terminal which is in a poor wireless state, the transmission bandwidth is limited, and placing a burden on the terminal due to too much current consumption caused by the transmission power that has become too high is prevented as well. Further, in the case where the battery voltage drops due to a decrease in the battery capacity or the like, the transmission quality deteriorates due to warp of transmission waves because a desired current consumption cannot be obtained. Therefore, deterioration of the transmission quality is prevented by decreasing the maximum transmission power. In addition, a method of saving power consumption of a communication system and a data transmission apparatus capable of selecting a plurality of communication paths is disclosed (Patent Document 1).

### Patent Document 1: Japanese Patent Application Laid-Open Publication No. 2006-237849

### SUMMARY OF INVENTION

### Technical Problem

Due to the above mentioned problems, in the case where a mobile terminal (MN: Mobile Node) using a plurality of wireless communication methods and performing transmissions simultaneously using a plurality of wireless devices (wireless communication units) is operated by a battery, when a high transmission power is required for both devices, or the current consumption for one device is not large but that for another device is large or the like, a heavy burden is placed on a battery of a mobile terminal. In addition, in the case where the supply capacity of power source is exceeded or the like, there is a possibility that the transmission quality is deteriorated because a desired transmission power cannot be obtained, and packet errors are increased. In some cases, upward packets will not reach, and as a result, communication interruption occurs.

In addition, in the case of handoff between different networks or the like, by performing so-called Make-Before-Break scheme hand-over, which is, communication of a new path is started by using another wireless device during communication by an old path using a certain wireless device, a large amount of current consumption is required for both wireless devices when communication of the new path is started, which may end up circumstances such as deteriorated communication quality of the old path, incapability in establishing communications of the new path or the like. Further, in some cases, there is a possibility that operations of a mobile terminal will be unstable because the current consumption for another device of the terminal cannot be obtained instantaneously.

For example, in a wireless communication terminal apparatus such as PDA and PC, with respect to a plurality of wireless communication units (wireless devices), mainly, one of the wireless communication units is onboard and another one is populated by a card or the like. Therefore, since each of the wireless communication units under communication consumes electrical power in the apparatus according to respective circumstances, there is a problem that electrical power of the entire apparatus cannot be controlled. In addition, as for the respective wireless communication units, since the control mechanism is becoming increasingly advanced and complicated, most of them control the wireless bandwidths and communication methods/modes or the like to the optimum ones automatically and adaptively according to a radio wave environment represented by RSSI. Such modifications of wireless bandwidths and communication methods/modes or the like cause fluctuations (increases and decreases) of current consumption. Then in some cases, a scene in which too much electrical power is used by an entire apparatus (particularly, when a communication unit is combined at the time of hand-over) is appeared. Further, with respect to electrical power consumption, although there is a factor of data allocation (transmission ratio), control means for controlling a plurality of wireless communication units as a whole by taking these various factors into account has not been developed.

Therefore, an object of the present invention is to provide a wireless communication terminal apparatus that avoids inconvenience caused by an increase in the current consumption when communications are performed using more than one wireless communication units.

### Solution to Problem

A wireless communication terminal apparatus (apparatus) according to the present invention to solve the above mentioned various problems is a wireless communication terminal apparatus having a plurality of wireless communication units having respectively different communication methods and capable of simultaneously performing wireless communications through respective wireless communication paths (i.e. base station) using the plurality of wireless communication units, comprises:

a received signal strength acquisition unit (a circuit or the like) for acquiring (calculating, determining) a received signal strength of each wireless communication unit;

a data allocation unit (a circuit or the like) for allocating data to be transmitted to each wireless communication unit based on a transmission ratio (received from a corresponding party or determined by a self terminal);

a transmission bandwidth acquisition unit (a circuit or the like) for acquiring, for each of the wireless communication units, each transmission bandwidth allocated by the data allocation unit to each wireless communication unit;

a predicted value calculation unit (a circuit or the like) for determining, (using an operation unit (a processor such as CPU and DSP)), based on each received signal strength acquired by the received signal strength acquisition unit and each transmission bandwidth acquired by the transmission bandwidth acquisition unit, with reference to a transmission-bandwidth versus current-consumption table showing a relationship among transmission bandwidth, received signal strength and current consumption; and

a transmission path control unit (a circuit or the like) for controlling the allocation unit to modify and allocate the transmission ratio so that a total of each current consumption predicted value determined by the predicted value calculation unit may not exceed a predetermined threshold; wherein

it is preferred that the control unit controls the allocation unit to allocate by modifying the transmission ratio so that the total of each current consumption predicted value of each wireless communication unit may be a minimum value.

In addition, the wireless communication terminal apparatus according to an embodiment of the present invention further comprises:

a current consumption measurement unit for measuring current consumption of each of the wireless communication units while acquiring a received signal strength by the received signal strength acquisition unit;

a current consumption table creation unit (a circuit or the like) for creating the transmission-bandwidth versus current-consumption table showing a relationship among transmission bandwidth, received signal strength and current consumption, while performing transmission per transmission bandwidth by each wireless communication units, acquisition of a received signal strength by the received signal strength acquisition unit, and measurement of current consumption for each wireless communication unit by the current consumption measurement unit; and

a storage unit (memory, HDD or the like) for storing the transmission-bandwidth versus current-consumption table showing a relationship among transmission bandwidth, received signal strength and current consumption created by the current consumption table creation unit for each of the wireless communication units; wherein

the predicted value calculation unit determines, based on each received signal strength acquired by the received signal strength acquisition unit and each transmission bandwidth acquired by the transmission bandwidth acquisition unit, with reference to the transmission-bandwidth versus current-consumption table stored in the storage unit, each current consumption predicted value of each wireless communication unit to which the data to be transmitted has been allocated.

Further, in the wireless communication terminal apparatus according to another embodiment of the present invention (receives a modification instruction of the transmission ratio from a corresponding party through any one of the wireless communication units or modifies the transmission ratio by the self terminal), the predicted value calculation unit calculates, when modifying the transmission ratio, each current consumption predicted value after the modification of the transmission ration which is required for transmitting each data when the data to be sent is allocated according to the transmission ratio after the modification, and the control unit controls the data allocation unit to correct the transmission ratio after the modification so that a total of each current consumption predicted value after the modification of the transmission ratio determined by the predicted value calculation unit may not exceed the predetermined threshold and to allocate at the transmission ratio after the correction.

Moreover, the wireless communication terminal apparatus according to another embodiment of the present invention further comprises an efficiency calculation unit for calculating respectively a current consumption predicted value per transmission bandwidth of each wireless communication unit (using an operation unit), and the control unit controls the data allocation unit to allocate data by modifying a transmission ratio as a transmission ratio of a wireless communication unit whose current consumption predicted value per the transmission bandwidth (i.e. current consumption predicted value/transmission bandwidth) calculated by the efficiency calculation unit is larger is reduced so that a total of each current consumption predicted value determined by the predicted value calculation unit may not exceed the predetermined threshold.

Further, in the wireless communication terminal apparatus according to another embodiment of the present invention, the predicted value calculation unit calculates, during communication by one or more wireless communication units among the plurality of wireless communication units, before starting communication by a new wireless communication unit, each current consumption predicted value of the one or more wireless communication units and a current consumption predicted value of the new wireless communication unit when the communication is started, and the control unit controls the one or more wireless communication units (or one or more wireless communication units through the data allocation unit), by decreasing at least one of the transmission bandwidths of the one or more wireless communication units under communication, so that the total of each current consumption predicted value when starting the communication determined by the predicted value calculation unit may not exceed the predetermined threshold.

As mentioned above, a means for solution according to the present invention has been described as an apparatus. However, the present invention can be realized as methods, programs and storage media that store programs, which are practically equivalent to them, and it will be appreciated that they fall within the scope of the present invention.

### Advantageous Effects on Invention

According to the present invention, by grasping the transmission capacity of each wireless device of a terminal, it is possible to avoid performing transmissions exceeding the battery capacity of the terminal even if a plurality of terminals perform transmission simultaneously. In addition, because of this, a burden is not placed on the operations of the terminal. Thus in the case of handoff to a different network, the influence to the communication quality is decreased, thus execution of handoff without placing a burden on the terminal can be realized.

### BRIEF DESCRIPTION OF DRAWINGS

FIG. 1 is a graph illustrating the relationship among transmission power, RSSI and transmission rate (bandwidth) of a communication terminal;

FIG. 2 is a configuration diagram of a network consisting of a mobile node (MN), a switching server (SS) and a VoIP corresponding party (CN);

FIG. 3 is a function block diagram of the mobile node and the switching server according to an embodiment of the present invention;

FIG. 4 is a flow chart illustrating operations in which a current consumption table creation unit 140 of FIG. 3 creates a lowest bandwidth current consumption table when transmissions are performed at the lowest transmission bandwidth;

FIG. 5 is a diagram showing an example of a lowest bandwidth current consumption table of a certain wireless device;

FIG. 6 is a flow chart illustrating operations in which the current consumption table creation unit 140 of FIG. 3 creates a transmission bandwidth current consumption table.

FIG. 7 is a diagram showing an example of a transmission bandwidth current consumption table for a certain wireless device;

FIG. 8 is a flow chart illustrating a process of a transmission path control unit when the mobile node starts communication by a new wireless device during communication by a certain wireless device;

FIG. 9 is a flow chart illustrating operations of the transmission path control unit when a transmission ratio of the mobile node is modified upon instruction from the switching server; and

FIG. 10 is a flow chart illustrating operations of the transmission path control unit when a transmission ratio of the mobile node is determined by the mobile node itself.

### DESCRIPTION OF EMBODIMENTS

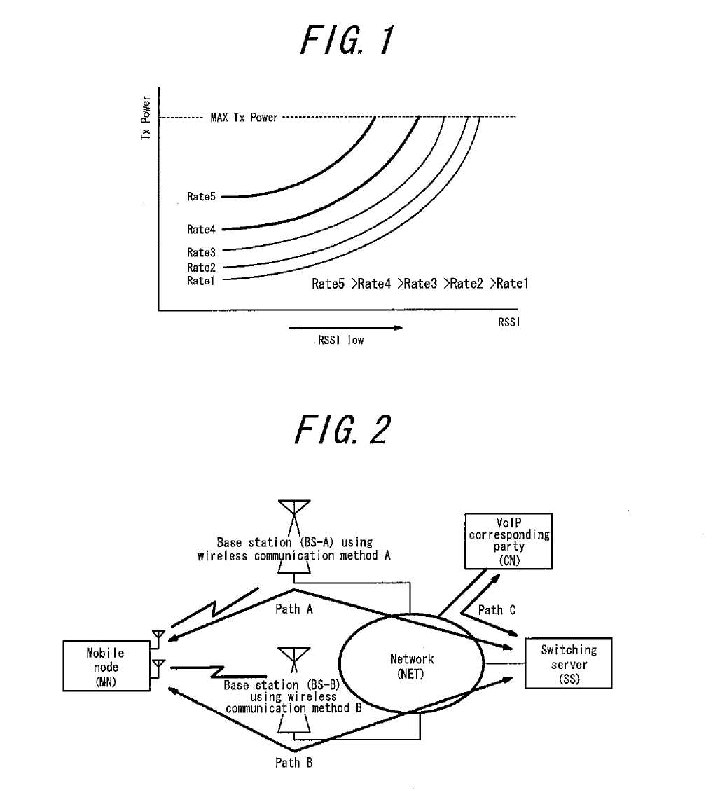

Hereinafter, preferred embodiments of the present invention are described in more detail with reference to the accompanying drawings. FIG. 2 is a configuration diagram of a network including a mobile node (MN), a switching server (SS) and a VoIP corresponding party (CN). The mobile node has wireless communication units (wireless devices) of a wireless communication method A and a wireless communication method Bandwidth, by using different addresses A and B allocated respectively, performs communications with the switching server (SS) through different wireless networks and networks (NET) such as the Internet. The VoIP corresponding party (CN) is the corresponding party of the mobile node (MN) for VoIP. However, by the intermediation of the switching server (SS) through tunneling between the mobile node and the switching server using an address C, the VoIP corresponding party and the mobile node use the address C as a destination and a source respectively. Then communication packets between the mobile node and the VoIP corresponding party establish communications between the mobile node and the VoIP corresponding party (in other words, the switching server functions as a home agent). At this time, a path A and a path B can be used simultaneously, and a transmission side sorts transmission packets to either of the paths so that reception can be performed optimally for an application in use. On this occasion, in the mobile node and the switching server, by monitoring the reception bandwidth of each path and by notifying the bandwidth by which the transmission side can transmit at present based on the reception bandwidth, it is possible to designate the ratio used by the path by which the corresponding party transmits, or in the mobile node, it is possible to determine the allocation ratio of a transmission path based on a wireless state. Hereinafter, explanation is given by assuming that both the mobile node and the switching server basically notify transmission ratios each other.

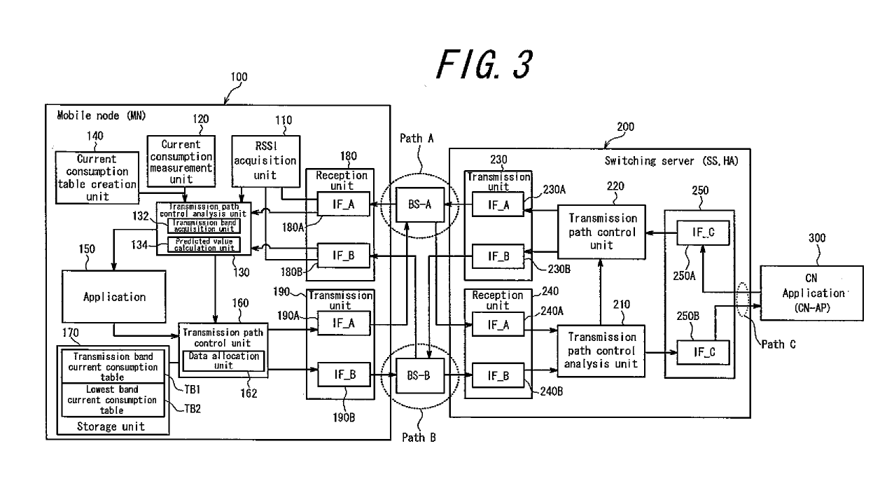

FIG. 3 is a function block diagram of the mobile node and the switching server according to an embodiment of the present invention. The mobile node (MN) 100 according to the present invention includes an RSSI acquisition unit 110, a current consumption measurement unit 120, a transmission path control analysis unit 130, a current consumption table creation unit 140, an application 150, a transmission path control unit 160, a storage unit 170, a reception unit 180, a transmission unit 190 and antennas (not shown). Further, in the present embodiment, the RSSI acquisition unit that acquires “RSSI”, which is a kind of indicator of received signal strength, is used as a received signal strength acquisition unit for acquiring received signal strengths. The mobile node (MN) 100 performs communications with the switching server 200 through a base station BS-A that uses a wireless communication unit A and a base station BS-B that uses a wireless communication unit B. The mobile node (MN) 100 has two wireless devices, that is, the wireless communication unit A for the path A and the wireless communication unit B for the path B. The wireless communication unit A is composed of a reception interface (IF_A) 180A for the path A in the reception unit 180 and a transmission interface (IF_A) 190A for the path A in the transmission unit 190. The wireless communication unit B is composed of a reception interface (IF_B) 180B for the path B in the reception unit 180 and a transmission interface (IF_B) 190B for the path B in the transmission unit 190. In this specification, for simplicity, like each reception unit 180 and transmission unit 190, reception and transmission are mentioned separately. However, practically, each of them will be one wireless device (e.g. a style such as a wireless card) including both transmission and reception.

In the transmission path control analysis unit 130, a ratio notification is acquired from a packet received by each reception interface of the reception unit 180 and is passed to the transmission path control unit, and when the received packet is the packet of application use, the packet is sent to the application 150. On the other hand, when “a path allocation ratio” is determined by the mobile node itself, a transmission bandwidth acquisition unit 132 provided in the transmission path control analysis unit 130 may determine the ratio based on the RSSI or the like of each wireless device (each reception interface of the reception unit) acquired by the RSSI acquisition unit 110 and notify the transmission path control unit 160 of it. In addition, in the transmission path control analysis unit 130, when the transmission ratio of the switching server 200 is notified to the switching server (SS, HA: Home Agent) 200, inflow from each wireless device (i.e. each interface of IF_A and IF_B) is monitored and compared to a necessary bandwidth of application as well to sequentially calculate an optimal transmission rate of the switching server 200, then a notification packet to the switching server 200 is created and sent to the transmission path control unit 160. In addition, the transmission path control analysis unit 130 further includes a predicted value calculation unit 134 and can calculate the predicted current value of each of wireless devices and the total of them before communication is started (particularly before a transmission that consumes a large amount of current) with reference to the tables described hereinafter.

The RSSI acquisition unit 110 acquires the RSSI of each wireless device from the wireless device (reception unit 180). The current consumption measurement unit 120 may measure the current consumption of each wireless device of the mobile node 100 or, when measurement of the current consumption of each wireless device cannot be performed separately, measure the total current consumption. In that case, the current consumption required for the communication of each wireless device is measured by measuring the current consumption used for the communication of one wireless device based on the measurement of the case where transmissions and receptions with other than the one wireless device is not performed.

The current consumption table creation unit 140 acquires, from the case where transmissions are performed by each wireless device at the lowest transmission rate (bandwidth), an increase amount of the current consumption along with a transmission rate (transmission bandwidth) in the case where transmissions are performed at a certain transmission bandwidth, and writes them into a transmission bandwidth current consumption table TB1 and a lowest bandwidth current consumption table TB2 provided in the storage unit 170. When the table is created actively, a ratio of the path for one wireless device is notified to the transmission path control unit 160 as 100% under a static environment where RSSI will not fluctuate, then test transmission packets to the switching server 200 are transmitted to the transmission path control unit 160 at a predetermined transmission rate under a state where communications are not performed by the other wireless devices, then the transmission bandwidth of the wireless device and the increase amount of the current consumption are written in the table. In addition, when the table is not created actively, RSSI, transmission bandwidth and current consumption may be written into the table together when some kind of communication occurs. Thus a three-dimensional table (not shown) showing the relationship among these three elements, which is, RSSI, transmission bandwidth and current consumption is created.

The transmission path control unit 160 includes a data allocation unit 162, which allocates transmission packets transmitted from the application 150 to each wireless device based on the “transmission ratio” notified from the transmission path control analysis unit 130 and the reference results of the tables TB1 and TB2.

Next, a configuration of the switching server 200 is described. The switching server 200 includes a transmission path control analysis unit 210, a transmission path control unit 220, a transmission unit 230, a reception unit 240 and a path C side communication unit 250. As in the case of the mobile node 100, the wireless communication unit A of the switching server 200 is composed of a transmission interface (IF_A) 230A for the path A in the transmission unit 230 and a reception interface (IF_A) 240A for the path A in the reception unit 240. The wireless communication unit B is composed of a transmission interface (IF_B) 230B for the path B in the reception unit 230 and a transmission/reception interface (IF_B) 240B for the path B in the reception unit 240. In addition, the switching server 200 further includes the path C side communication unit 250, which is a communication interface for the path C to an application (CN-AP) 300 of the corresponding party (CN), and path C side communication unit 250 is divided into a reception unit 250A and a transmission unit 250B. In this manner, for simplicity as in the case of the mobile node, one communication interface is divided into two, such as In and Out. Further, the communication interface is divided into three, such as for the paths A, Bandwidth C. However, these paths may be composed of one interface. In the case of one interface, path will be divided according to a destination address when transmissions are performed.

In the transmission path control analysis unit 210, a ratio notification is acquired from a packet received by the reception interface (IF_A) 240A for the path A and the reception interface (IF_B) 240B for the path B of the reception unit 240 and is passed to the transmission path control unit 220, and when the received packet is the packet of application use, the packet is sent to the path C side communication unit 250 (IF_C) of the switching server 200 and then transmitted to the application (CN-AP) of the corresponding party. In addition, in the transmission path control analysis unit 210, when a transmission ratio of the server (SS) 200 is notified to the switching server 200, inflow from each wireless device is monitored and compared to a necessary bandwidth of the application as well to sequentially calculate an optimal transmission ratio for the server 200, then a notification packet to the server (SS) 200 is created and sent to the transmission path control unit 220.

In the transmission path control unit 220, based on the ratio notified from the transmission path control analysis unit, transmission packets transmitted from the application are allocated to each device (or destination address). An explanation of FIG. 3 is given above, and an explanation of the case where VoIP is used as an application is given hereinafter.

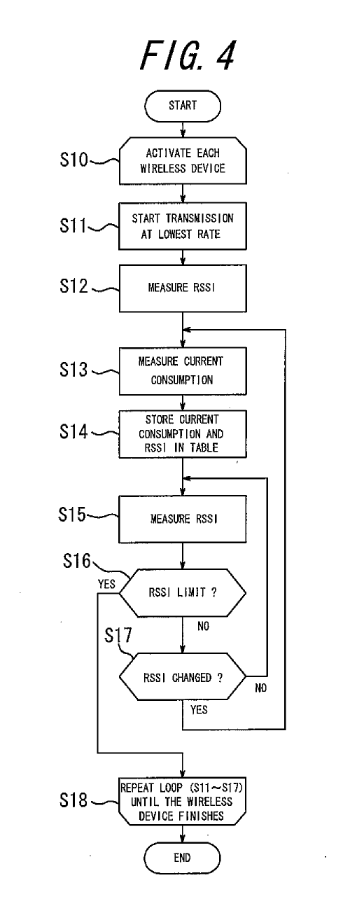

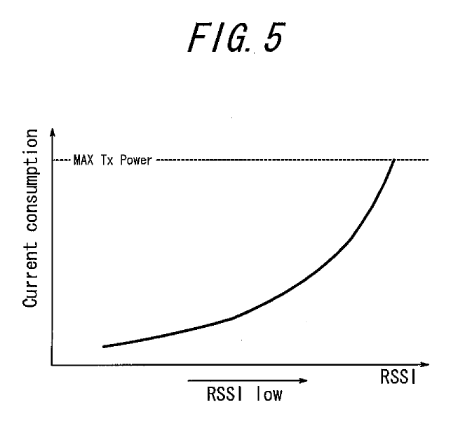

FIG. 4 is a flow chart illustrating operations in which a current consumption table creation unit 140 of FIG. 3 creates a lowest bandwidth current consumption table when transmissions are performed at the lowest transmission bandwidth. As mentioned above, in general, for a wireless communication system, when transmissions are performed at a certain transmission bandwidth, only a small amount of transmission power is required if the RSSI is high. However, when the RSSI is low, a large amount of transmission power is required even in the case where transmissions are performed at the lowest bandwidth (rate), thus a large amount of current consumption is required. In this process, measurement before shipment of terminals at a factory or the like is assumed. Moreover, it is assumed that the RSSI sequentially changes from a high state to a low state during communication. In addition, it is assumed that not only communications but also other functions and processes inside a terminal are not performed with respect to wireless devices except for the device to be measured. At first, one wireless device is activated (step S10). Then transmission is started by the wireless device at the lowest bandwidth (e.g. in the case of VoIP using G711 Codec, 50 normal RTP packets of payload size of 160 byte can be transmitted per second, and it is 64 kbps at an IP level. However, as an example of the lowest rate, one packet is transmitted per second and it is 64× 1/50=1.28 kbps) (step S11).

Next, in steps S12 and S13, measurements of RSSI and current consumption are performed while performing transmissions. Then, the measured current consumption and RSSI are stored in a table (step S14). Then, in step S15, RSSI is measured, and whether the RSSI is the RSSI of the limit for reception, in other words, whether the RSSI reaches the RSSI limit of reception sensitivity point or not is determined. In the case of NO, whether the RSSI has changed or not is determined (step S16). When the RSSI has changed, the process returns to step S13, and the current consumption is measured again and the current consumption and the RSSI are stored in the table (step S14). In step S16, if it is determined that the RSSI has not changed, steps S15, S16 and S17 are repeated and the process waits until the RSSI changes. In this manner, the relationship between the RSSI and the current consumption are stored in the table. Then at the point in time when it is determined that the RSSI reaches the limit of reception in step S16, the table creation is finished, and measurement of the next wireless device is started. In this manner, a table of current consumption at the lowest rate relative to the RSSI can be created for each of the wireless devices. FIG. 5 is a graph showing an example of a lowest bandwidth current consumption table of a certain wireless device created by the above mentioned process.

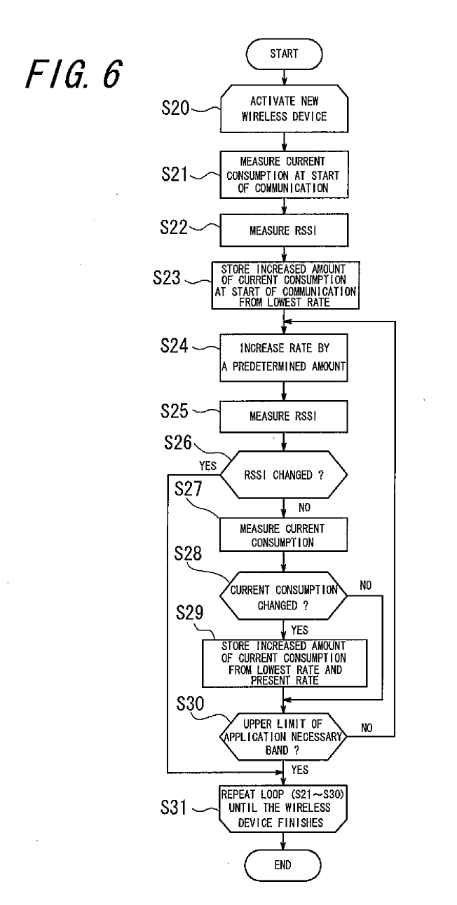

FIG. 6 is a flow chart illustrating operations in which the current consumption table creation unit 140 of FIG. 3 creates a transmission bandwidth current consumption table. Assume a static environment where RSSI does not change. In addition, assume that operations are repeated for the number of times equal to the number of wireless devices included in the mobile node, and when operations are performed to one wireless device, the other devices do not operate. After operation is started, communication is started by activating a new wireless device as the first wireless device (step S20) and the current consumption used at the start of communication is measured as well (step S21). Next, in step S22, the RSSI at that time is measured (in the case of a wireless device of the normal cellular system, a call request is performed to a base station at the time of activation or when communication is started from an idle state. However, in this case, since a transmission power larger than that required during a normal communication is required, a large amount of current consumption is required temporarily (momentarily)). After measurement, the process moves to step S23, and with reference to the table showing the relationship between the RSSI and the current consumption created at the time of transmission at the lowest bandwidth required by the process in FIG. 4, the current consumption offset=(the current consumption at the start of communication−the current consumption transmission at the lowest bandwidth transmission) at the start of communication is calculated under the same RSSI, and stored as a current consumption offset at the start of communication.

Next, in step S24, transmission of the test packets to the switching server is started at the transmission bandwidth that has been increased by a predetermined amount (e.g. in the case of a VoIP using G711 Codec, 50 normal RTP packets of payload size of 160 byte can be transmitted per second, and it is 64 kbps at an IP level. However, as an example of the predetermined rate, 2 packets are transmitted per second and it is 64× 2/50=2.56 kbps). Then, the RSSI is measured during transmission at the transmission bandwidth (step S25) and whether the RSSI has changed or not is determined (step S26). When the RSSI has changed, creation of a table by this wireless device is discontinued and the process is finished. In step 26, if it is determined that the RSSI has not changed, the process moves to step S27 and the current consumption is measured. Next, in step S28, whether the measured current consumption has changed or not is determined. Then when it has changed (the present current consumption−the current consumption at the time of transmission at the lowest transmission bandwidth) is stored in the table with the present bandwidth (rate) (step S29). When it is determined that the current consumption has not changed in step S28, the step S29, which is a memory step, is skipped, then the process moves to step S30. In step S30, whether the present transmission bandwidth is the upper limit of the necessary bandwidth for the application or not is determined (in the example of aforementioned G711, 50 packets/sec.=64 kbps). If it is not the upper limit, the process returns to step S24 and the transmission bandwidth (rate) is increased again by the predetermined amount. Then RSSI is measured, and if the RSSI has not changed, the current consumption is measured. After that, these steps are repeated. Then when the present bandwidth reaches the upper limit (50 packets/sec.) of the necessary bandwidth of the application, the table creation by this wireless device is considered to have been completed, and communication of the wireless device is finished. Then measurement is performed for the next wireless device. These steps are repeated and a transmission bandwidth current consumption table is created for all of the wireless devices included in the mobile node. The above mentioned measurement is required to be performed under a static environment where a reception level does not change. However, a table may be created by performing measurement at the time of shipment of terminals, or measurement may be performed under the sate where totally no terminal is used such as at midnight. Further, in this case, the necessary bandwidth for the application is defined as the upper limit. However, it should be noted that the element is not limited to this, and the table may be created based on other elements.

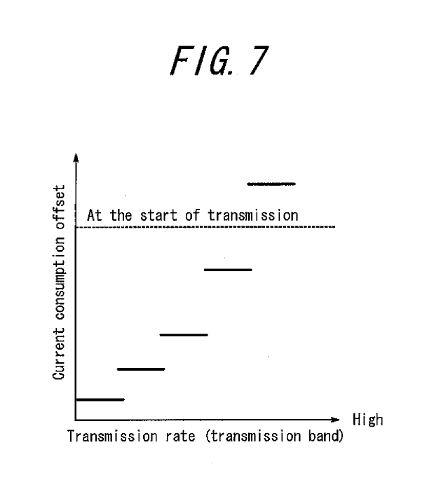

FIG. 7 is a graph showing an example of a transmission bandwidth current consumption table of a certain wireless device created by the above mentioned steps. In the normal communication system, as mentioned in the explanation of the background art, the wireless frame, the transmission rate or the like are determined in accordance with the levels, and IP packets are transmitted at a certain frame length and a certain transmission rate by fragment, padding or the like (e.g. in the case of cdma2000 1xEV-DO Rev.0, the terminal transmission bandwidth (rate) is determined in accordance with 5 levels between 9.6 kbps˜153.6 kbps). After that, when transmissions are performed by this device, by measuring the RSSI, when transmissions are performed at a certain bandwidth (rate), an increase amount of the current consumption at the start of transmission (communication) (the broken line in FIG. 7) and an increase amount of the current consumption when transmissions are performed at a predetermined bandwidth (rate) can be calculated based on the lowest bandwidth current consumption table and transmission bandwidth current consumption table. In addition, by adding the calculated increased amount (predicted value) to the present current consumption under an idle state, a predicted value of the current consumption after the start of transmission can be determined before the start of transmission.

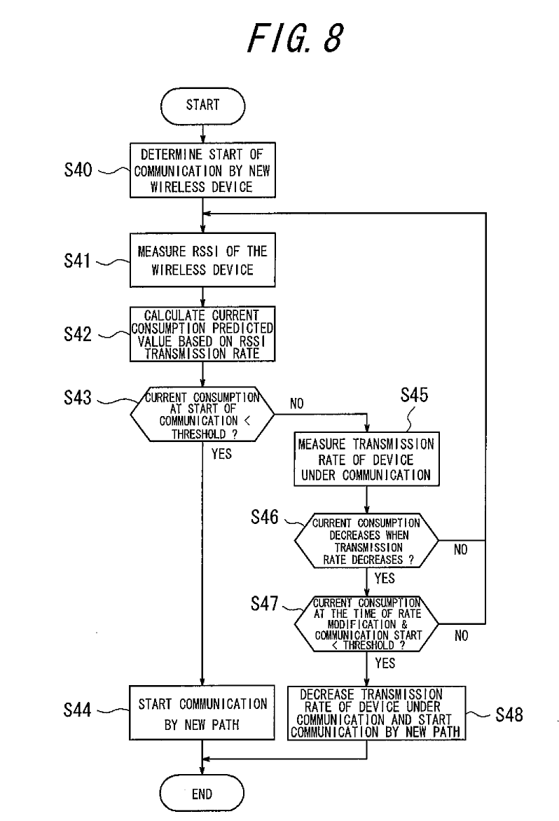

FIG. 8 is a flow chart illustrating a process of the transmission path control unit in which the mobile node starts communication by a new wireless device during communication by a certain wireless device. It is assumed that the wireless device that starts communication from now is in a standby mode or a dormant mode (the sate where a lower-level layer is cut, but an upper-level layer is in a communication maintenance state, which is, the state where communication can be started immediately). When a start of communication by the new wireless device is determined (step S40), the present RSSI of the new wireless device is measured (step S41). Then after that, the total current consumption of the mobile node is measured. Then, in step S42, with reference to the lowest bandwidth current consumption table and the transmission bandwidth current consumption table (FIG. 5 and FIG. 7), a current consumption predicted value at the start of communication on the occasion where communication is started by the new wireless device is calculated. Next, whether the current consumption predicted value at the start of communication exceeds a threshold (e.g. 800 mA) or not is determined (step S43). If it is determined that the threshold is not exceeded, communication is started by the new device leaving the state as it is (step S44). When it is determined that the threshold is exceeded in step S43, the transmission bandwidth of the wireless device under communication at present is measured or acquired, then whether the current consumption decreases when the transmission bandwidth decreases or not is determined based on the transmission bandwidth current consumption table (step S46). If it is determined that the current consumption decreases, the process moves to step S47. Then whether the current consumption predicted value, which is the total of the current consumption when the transmission bandwidth (rate) is modified and the current consumption when communication is started by the new wireless device, exceeds the threshold or not is determined. If it is determined that the threshold is not exceeded in step S47, the process moves to step S48, and communication is started by the new wireless device by decreasing the transmission bandwidth (rate) of the wireless device under communication. If the determination conditions of steps S46 and S47 are satisfied, the process returns to step S41. Then RSSI measurement of the new wireless device is performed. Then after that, a sequence of steps is repeated.

By the above mentioned steps, inconveniences such as interruption of communication caused by the current consumption exceeding the battery capacity as a result of inadvertent start of communication by the new wireless device due to impossibility of obtaining a predetermined transmission power of the wireless device under communication at present, and an unstable state of the operation of the other devices in the mobile node caused by insufficient current, can be prevented. Further, although not shown in the flow chart, because a large transmission power is required at the start of communication, however, after communication has been established, transmission power is required according to the transmission bandwidth, thus the transmission power is small in the case where the transmission bandwidth is not high, even in the case where communication by the new wireless device is started by decreasing the transmission bandwidth of the wireless device which has been under communication, it is possible to return the bandwidth to its original state in the case where the total of the current consumption does not exceed the threshold when communications are performed by returning the transmission bandwidth to its original state after communication has been established. In addition, in the case where VoIP is performed, when Soft Phone does not transmit silent signals or decreases the transmission bandwidth, by waiting for the period, it is possible to start transmission of a new device by eliminating the influence to phone calls due to decrease in bandwidth.

In addition, in the case where an application is a VoIP of real-time communication or the like, even when handoff between different networks (e.g. handoff between an EVDO and a mobile WiMAX) is performed by two wireless devices, by separating an old path after communication has been established by a new communication path through the above mentioned steps at the time of handoff, it is possible to shorten a switching time and perform handoff by minimizing the influence to the telephone calls without placing a burden on a terminal. Further, in this case, RTP packets temporally remain when communication of the new path is started by decreasing the rate of the old path. In this case, the influence to the quality of telephone calls can be diminished by preventing wasted packets from being flowed in the new path by performing process such as, when packets are in a silent interval, the packets are discarded, or, based on the measurement of a retention time, the packets which have not been in time for reproduction of buffer are discarded or the like.

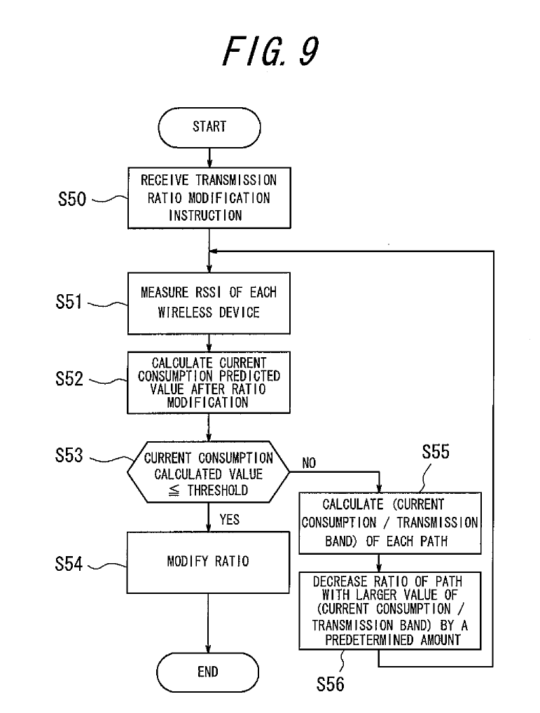

FIG. 9 is a flow chart illustrating operations of the transmission path control unit in the case where a transmission ratio of the mobile node is modified upon instruction from the switching server. In step S50, when a modification instruction of the transmission ratio is received from the switching server (SS), the current consumption of the wireless device under communication is measured and the RSSI is measured (step S51). Then in step S52, “a current consumption predicted value after ratio modification” is calculated with reference to the lowest bandwidth current consumption table and the transmission bandwidth current consumption table. In step S53, the calculated predicted value is compared to a threshold, and if the predicted value is smaller, the ratio is modified (step S54). In step S53, if it is determined that the predicted value exceeds the threshold, the process moves to step S55, then values of “current consumption/transmission bandwidth” are calculated for each of the wireless devices (paths), then the ratio of the path whose value is higher is reduced by a predetermined amount (e.g. 2/50 packets=4%) (step S56). In other words, the ratio of the inefficient path whose current consumption per bandwidth is high is decreased. After that, the process returns to step S51 and the RSSI is measured again, then a sequence of steps, in which the current consumption value after the ratio is modified to a new ratio is calculated and compared to the threshold, is performed. At the point in time when the current consumption becomes equal to or less than the threshold after repeating the steps, in other word, when the conditions of step S53 are satisfied, the process exits from the sequence of steps and moves to step S51. Then the ratio is modified and the process is finished. By the above mentioned steps, circumstances where the current consumption exceeds the battery capacity due to inadvertent modification of the ratio can be avoided.

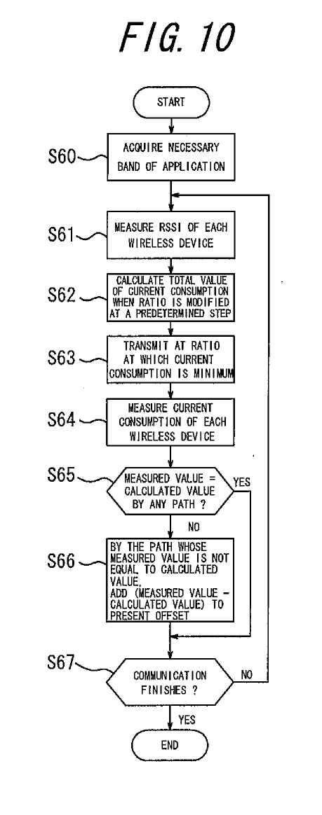

FIG. 10 is a flow chart illustrating operations of the transmission path control unit in the case where the transmission ratio of the mobile node is determined by the mobile node itself. When transmission is started, in step S60, at first, a necessary bandwidth (e.g. 64 kbps) is acquired from the application. Then, in step S61, the RSSI of each wireless device is measured. After that, in step S62, the ratio for transmission is modified according to a predetermined step (e.g. in the case of 50 packets/sec., 0:50, 5:45, 10:40, 15:35, 20:30, 25:25, 30:20, 35:15, 40:10, 45:5 and 50:5), then the total of each current consumption of a wireless device relating to each occasion is calculated. Next, in step S62, transmission (communication) is started at a ratio at which the calculated current consumption total is the smallest, then the current consumption is measured again (step S64). The measured value and the calculated value are compared (step S65), and if the measured value is not equal to the calculated value by any of the wireless devices (e.g. in the case where an upward traffic is heavy or the like, even at the same transmission rate, transmission power larger than the case where a traffic is not heavy is required), For the wireless device whose measured value is not equal to the calculated value, (the measured value−the calculated value) is added to the present current consumption offset, and determined as a new current consumption offset (step S66). After that, whether the communication finishes or not is determined in step S67. Then if the communication continues, the process returns to step S61 and measurement of the RSSI of each wireless device is performed again. Then the current consumption when the ratio for transmission is modified according to the predetermined step is calculated. Then transmissions are performed by modifying to the ratio at which the calculated value is the smallest. Above steps are repeated until the communication finishes. By performing the above mentioned steps, it is possible to determine the ratio by itself by taking the wireless state of the transmission of MN into account. Further, by reducing the current consumption, it is possible to avoid the circumstances where the current consumption exceeds the threshold by inadvertent increase in the transmission power and improve the battery life as well.

The present invention has been explained based on the drawings and embodiments. However, it should be noted that those skilled in the art will readily be able to perform various changes and modifications based on this disclosure. Therefore, it should be noted that these changes and modifications fall within the scope of the present invention. For example, function or the like included in, for example, each unit, each step or the like can be rearranged without causing logical contradictions, and a plurality of units and steps can be combined or divided.

### CROSS REFERENCE TO RELATED APPLICATION

This application claims priority to and the benefit of Japan Patent Application No. 2006-322130 (filed on Nov. 29, 2006), the entire contents of which are incorporated herein by reference.

1. A wireless communication terminal apparatus having a plurality of wireless communication units having respectively different communication methods and capable of simultaneously performing wireless communication through respective wireless communication paths using the plurality of wireless communication units, comprising:
a received signal strength acquisition unit for acquiring a received signal strength of each wireless communication unit;
a data allocation unit for allocating data to be transmitted to each wireless communication unit based on a transmission ratio;
a transmission bandwidth acquisition unit for acquiring, for each of the wireless communication units, each transmission bandwidth allocated by the data allocation unit to each wireless communication unit;
a predicted value calculation unit for determining, based on each received signal strength acquired by the received signal strength acquisition unit and each transmission bandwidth acquired by the transmission bandwidth acquisition unit, with reference to a transmission-bandwidth versus current-consumption table showing a relationship among transmission bandwidth, received signal strength and current consumption, each current consumption predicted value of each wireless communication unit to which the data to be transmitted has been allocated; and
a control unit for controlling the data allocation unit to modify and allocate the transmission ratio so that a total of each current consumption predicted value determined by the predicted value calculation unit may not exceed a predetermined threshold.

2. The wireless communication terminal apparatus according to claim 1, further comprising:
a current consumption measurement unit for measuring current consumption of each of the wireless communication units while acquiring a received signal strength by the received signal strength acquisition unit;
a current consumption table creation unit for creating the transmission-bandwidth versus current-consumption table showing a relationship among transmission bandwidth, received signal strength and current consumption, while performing transmission per transmission bandwidth by each wireless communication units, acquisition of a received signal strength by the received signal strength acquisition unit, and measurement of current consumption for each wireless communication unit by the current consumption measurement unit; and
a storage unit for storing the transmission-bandwidth versus current-consumption table showing a relationship among transmission bandwidth, received signal strength and current consumption created by the current consumption table creation unit for each of the wireless communication units; wherein
the predicted value calculation unit determines, based on each received signal strength acquired by the received signal strength acquisition unit and each transmission bandwidth acquired by the transmission bandwidth acquisition unit, with reference to the transmission-bandwidth versus current-consumption table stored in the storage unit, each current consumption predicted value of each wireless communication unit to which the data to be transmitted has been allocated.

3. The wireless communication terminal apparatus according to claim 1, wherein the predicted value calculation unit calculates, when modifying the transmission ratio, each current consumption predicted value after the modification of the transmission ration which is required for transmitting each data when the data to be sent is allocated according to the transmission ratio after the modification, and the control unit controls the data allocation unit to correct the transmission ratio after the modification so that a total of each current consumption predicted value after the modification of the transmission ratio determined by the predicted value calculation unit may not exceed the predetermined threshold and to allocate at the transmission ratio after the correction.

4. The wireless communication terminal apparatus according to claim 1, further comprising:
an efficiency calculation unit for calculating respectively a current consumption predicted value per transmission bandwidth of each wireless communication unit, wherein the control unit controls the data allocation unit to allocate data by modifying a transmission ratio as a transmission ratio of a wireless communication unit whose current consumption predicted value per the transmission bandwidth calculated by the efficiency calculation unit is larger is reduced so that a total of each current consumption predicted value determined by the predicted value calculation unit may not exceed the predetermined threshold.

5. The wireless communication terminal apparatus according to claim 1, wherein the predicted value calculation unit calculates, during communication by one or more wireless communication units among the plurality of wireless communication units, before starting communication by a new wireless communication unit, each current consumption predicted value of the one or more wireless communication units and a current consumption predicted value of the new wireless communication unit when the communication is started, and the control unit controls the one or more wireless communication units, by decreasing at least one of the transmission bandwidths of the one or more wireless communication units under communication, so that the total of each current consumption predicted value when starting the communication determined by the predicted value calculation unit may not exceed the predetermined threshold.
